(19) United States
(12) Patent Application Publication
(10) Pub. No.: US 2007/0013827 A1
(43) Pub. Date: Jan. 18, 2007

(54) Surface light source having interconnect optical film and optical element and liquid crystal display with the same

(75) Inventor: Chien-Chung Fang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/487,878

(22) Filed: Jul. 17, 2006

(30) Foreign Application Priority Data
Jul. 15, 2005 (TW) 94124087

(51) Int. Cl. G02F 1/1333

(52) U.S. Cl. 349/58

(57) ABSTRACT

A surface light source (50) includes a light source (53); an optical element (54) configured for receiving light beams from the light source, guiding and uniformizing the light beams, and outputting the light beams; an optical film (56) positioned on the optical element and configured for receiving the output light beams; and a frame (58) accommodating the light source, the optical element and the optical film. The surface light source further has at least one fastening post (542) being formed on one of the optical element and the optical film, and at least one fastening hole (562) being formed on one of the optical film and the optical element, which is corresponding to the at least one fastening post. The optical film is located at the optical element through the cooperation of the at least one fastening post and the at least one fastening hole.

### BACKGROUND OF THE INVENTION

1. Field of the Invention

The present invention relates to surface light sources and liquid crystal displays using the same, and more particularly to a surface light source having fastening means that interconnect an optical film with an optical element such as a light guide plate or a diffusing plate.

2. General Background

In general, LCDs have two main advantages in comparison with cathode ray tubes (CRTs): LCDs are thin, and have low power consumption. It has been said that LCDs might one day completely replace CRT display devices, and LCDs have aroused great interest in many industries in recent times. In general, an LCD needs a surface light source to provide even light for a clear display.

A surface light source generally has a light source and a light guide plate. The light source may be a light-emitting diode (LED), or one or more fluorescent lamps. The light guide plate has a thin end face through which light is introduced, and two opposite major faces one of which functions as an emission face.

The light guide plate functions to change a direction of propagation of light beams emitted from the light source and introduced into the light guide plate, from a direction roughly parallel to the emission face of the light guide plate to a direction perpendicular to the emission face. That is, the light guide plate effectively changes the linear or point light source(s) into a surface light source, for evenly illuminating a whole display screen of the LCD.

FIG. 3 shows a conventional surface light source 10, which has a frame 18, a light guide plate 14, a plurality of point light sources 13, a reflector 12, and an optical film assembly 16. The frame 18 has a pair of notches 181 defined in each of two opposite sidewalls (not labeled) thereof. The light guide plate 14 has a pair of first ears 141 extending from each of two opposite sides thereof. The optical film assembly 16 has a pair of second ears 161 extending from each of two opposite sides thereof. The second ears 161 correspond to the first ears 141 of the light guide plate 14. The optical film assembly 16, the light guide plate 14 and the reflector 12 are laminated one on the other in that order from top to bottom, and this subassembly is accommodated in the frame 18. The first and second ears 141, 161 of the light guide plate 14 and the optical film assembly 16 are received in the notches 181 of the frame 18. The frame 18 also accommodates the point light sources 13 therein, with the point light sources 13 being positioned adjacent to one side of the light guide plate 14. In use, light beams from the point light sources 13 enter the light guide plate 14 through an incident surface (not labeled) of said side of the light guide plate 14.

Each second ear 161 of the optical film assembly 16 and a corresponding first ear 141 of the light guide plate 14 are accommodated in a corresponding notch 181 of the frame 18 together, with the second ear 161 abutting the first ear 141. In general, the second ear 161 is thinner than the first ear 141. Further, the first ear 141 is sandwiched between the frame 18 and the second ear 161, whereas the second ear 161 is merely located in a topmost portion of the notch 181. Therefore if the surface light source 10 is subjected to shock, the second ear 161 is liable to shift position within the notch 181 or even slip out from the notch 181 altogether. When one or more of the second ears 161 are displaced, the optical film assembly 16 shifts slightly and may even disengage from the frame 18. Thus in mass manufacturing of the surface light source 10, the precision of the surface light source 10 may be unsatisfactory, and the assembly process may be retarded by the need for correction of the imprecision. In addition, the frame 18 is generally made from plastic, therefore the frame 18 generally has a low manufacturing precision. Thus even when the surface light source 10 is properly assembled, the optical film assembly 16 may not be precisely fixed in the frame 18, and the performance of the surface light source 10 may be diminished.

A new surface light source for an LCD which overcomes the above-mentioned disadvantages is desired. In particular, what is needed is a surface light source having optical components precisely positioned therein.

### SUMMARY

A surface light source includes a light source; an optical element configured for receiving light beams from the light source, guiding and uniformizing the light beams, and outputting the light beams; an optical film positioned on the optical element and configured for receiving the output light beams; and a frame accommodating the light source, the optical element and the optical film. The surface light source further has at least one fastening post being formed on one of the optical element and the optical film, and at least one fastening hole being formed on one of the optical film and the optical element, which is corresponding to the at least one fastening post. The optical film is located at the optical element through the cooperation of the at least one fastening post and the at least one fastening hole.

A liquid crystal display includes a liquid crystal panel, a surface light source providing surface light beams to the liquid crystal panel, and a frame for accommodating the liquid crystal panel and the surface light source. The surface light source has a light source; an optical element configured for receiving light beams from the light source, guiding and uniformizing the light beams, and outputting the light beams; an optical film positioned on the optical element and configured for receiving the output light beams. The liquid crystal display further has at least one fastening post being formed on one of the optical element and the optical film, and at least one fastening hole being formed on one of the optical film and the optical element, which is corresponding to the at least one fastening post. The optical film is located at the optical element through the cooperation of the at least one fastening post and the at least one fastening hole.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is an exploded, isometric view of an LCD according to a first embodiment of the invention.

FIG. 2 is an exploded, isometric view of an LCD according to a second embodiment of the invention.

FIG. 3 is an exploded, isometric view of a conventional surface light source, which is typically used in an LCD.

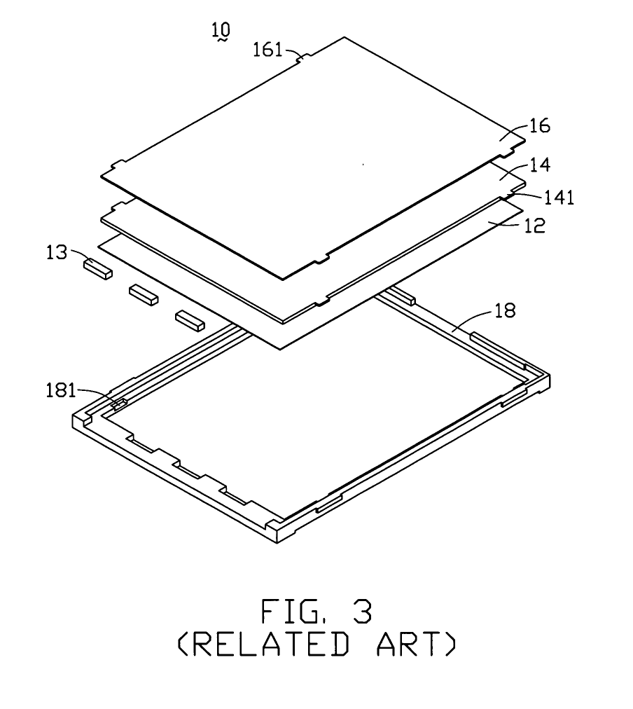

### DETAILED DESCRIPTION OF THE PREFERRED EMBODIMENTS

Hereinafter, preferred embodiments of the present invention will be described in detail with reference to the accompanying drawings.

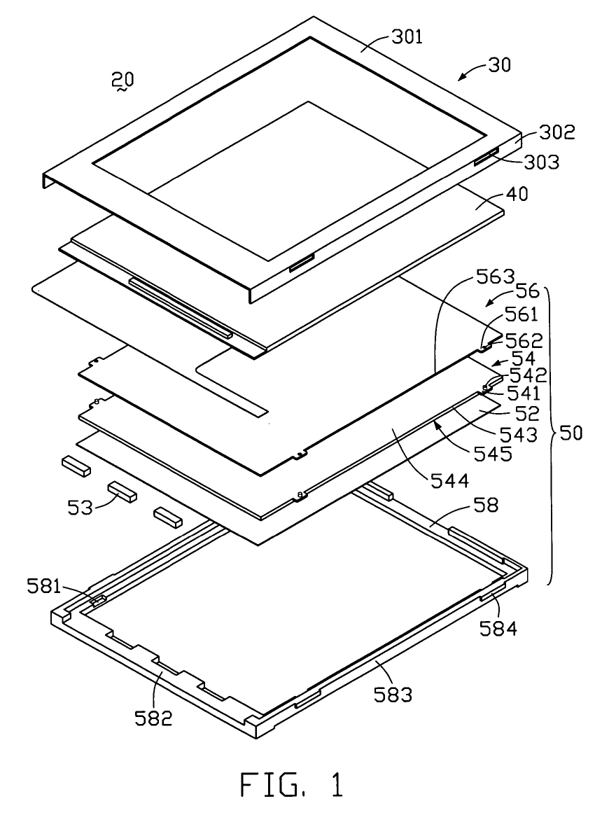

Referring to FIG. 1, a liquid crystal display 20 according to a first embodiment of the present invention includes a top bezel 30, a liquid crystal panel 40, and a surface light source 50, disposed in that order from top to bottom. The surface light source 50 includes an optical film 56, a light guide plate 54, a reflector 52, and a frame 58, disposed generally in that order from top to bottom. The frame 58 receives the liquid crystal panel 40, the optical film 56, the light guide plate 54, and the reflector 52 therein. In addition, the liquid crystal display 20 further includes a plurality of light sources 53 disposed adjacent one side of the light guide plate 54.

The top bezel 30 includes a top wall 301, and two opposite first side walls 302 integrally connecting with the top wall 301. The top wall 301 defines a rectangular first opening (not labeled), corresponding to a display area (not labeled) of the liquid crystal panel 40. The first side walls 302 perpendicularly extend down from opposite long sides (not labeled) of the top wall 301 respectively. Each first side wall 302 defines two hatches 303 therein. The top bezel 30 can be made from iron, aluminum, magnesium, or any other suitable metal or alloy.

The light guide plate 54 has two opposite side surfaces 543, a first top surface 544 perpendicularly adjoining the side surfaces 543, and a first bottom surface 545 opposite to the first top surface 544. Two rectangular first ears 541 integrally extend from each side surface 543. Each first ear 541 has a fastening post 542 formed thereon. The light guide plate 54 is used to introduce light beams from the light sources 53 into the light guide plate 54, from a direction roughly parallel to the first top surface 544 of the light guide plate 54 to a direction perpendicular to the first top surface 544. That is, the light guide plate 54 effectively changes the light sources 53 into a surface light source, for guiding and uniformizing the light beams over the whole first top surface 544, and outputting the light beams to the liquid crystal panel 40.

The optical film 56 has two opposite side surfaces 563, and two rectangular second ears 561 integrally extending from each side surface 563. A fastening through-hole 562 is defined in each second ear 561.

The frame 58 includes a bottom wall 582, and two second side walls 583 integrally connecting with the bottom wall 582. The bottom wall 582 is generally frame-shaped. Each second side wall 583 has a generally asymmetrical U-shape. The second side walls 583 extend perpendicularly up from two opposite sides (not labeled) of the bottom wall 582 respectively, and are symmetrically opposite each other. Outmost vertical faces of the bottom wall 582 are coplanar with corresponding outmost vertical faces of the second side walls 583. Each second side wall 583 includes two first protrusions 584 integrally extending perpendicularly outward from the outmost vertical face thereof that is at a corresponding long side (not labeled) of the frame 58.

In addition, the frame 58 further defines two pairs of first notches 581, positioned at two opposite inner long sides (not labeled) of the bottom wall 582 respectively. Each first notch 581 is located opposite to one respective first protrusion 584.

When the liquid crystal display 20 is assembled, the top bezel 30 and the frame 58 cooperatively accommodate the liquid crystal panel 40 and the surface light source 50 therebetween. The hatches 303 engagingly receive the first protrusions 584 therein, thereby locking the top bezel 30 and the frame 58 together. Each first notch 581 of the frame 58 receives a corresponding first ear 541 of the light guide plate 54 and a corresponding second ear 561 of the optical film 56 therein, and the fastening post 542 of the first ear 541 engages in the fastening through-hole 562 of the second ear 561. Thus, the above-described configuration can help to precisely position the second ears 561 in the first notches 581. In particular, the optical film 56 is precisely positioned relative to the light guide plate 54. Further, the second ears 561 are more securely retained in the first notches 581 by reason of the attachment of the second ears 561 to the first ears 541. Thus, the optical film 56 can be precisely and securely fixed in the frame 58, and the liquid crystal display 20 can provide good quality, reliable display images. In addition, the fastening posts 542 and the fastening through-holes 562 help an operator to assemble the liquid crystal display 20 more easily. In particular, once the fastening through-holes 562 of the optical film 56 engagingly receive the fastening posts 542 of the light guide plate 54, there is no need for the operator to further correct or adjust the location of the optical film 56.

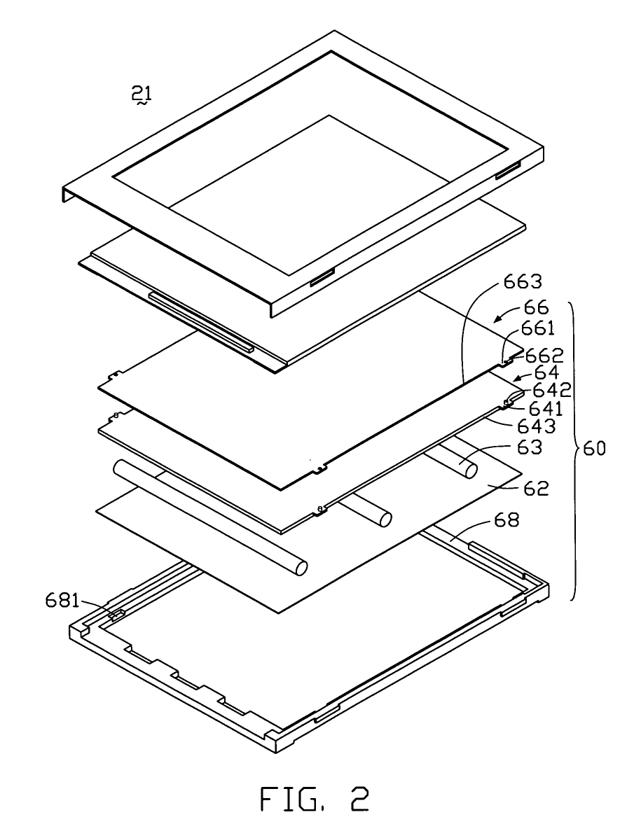

FIG. 2 shows a liquid crystal display 21 according to a second embodiment of the present invention. The liquid crystal display 21 has a structure similar to that of the liquid crystal display 20, except that the liquid crystal display 21 includes a surface light source 60. The surface light source 60 includes an optical film 66, a diffusing plate 64, a plurality of light sources 63, a reflector 62, and a frame 68, disposed generally in that order from top to bottom. The light sources 63 are linear light sources such as cold cathode fluorescent lamps (CCFLs), and are arranged parallel to each other.

The diffusing plate 64 has two opposite side surfaces 643. Two rectangular first ears 641 integrally extend from each side surface 643. Each first ear 641 has a fastening post 642 formed thereon. The diffusing plate 64 is used to diffusing and uniformizing the light beams from down-disposed the light sources 63 over the whole top surface, and outputting the light beams to the liquid crystal panel.

The optical film 66 has two opposite side surfaces 663, and two rectangular second ears 661 integrally extending from each side surface 663. A fastening through-hole 662 is defined in each second ear 661.

In assembly, the optical film 66, the diffusing plate 64, the light sources 63, and the reflector 62 are accommodated in the frame 68 in that order from top to bottom. Each first notch 681 of the frame 68 receives a corresponding first ear 641 of the diffusing plate 64 and a corresponding second ear 661 of the optical film 66 therein, and the fastening post 642 of the first ear 641 engages in the fastening through-hole 662 of the second ear 661. Thus, the above-described configuration can help to precisely position the second ears 661 in the first notches 681. In particular, the optical film 66 is precisely positioned relative to the diffusing plate 64. Further, the second ears 661 are more securely retained in the first notches 681 by reason of the attachment of the second ears 661 to the first ears 641. Thus, the optical film 66 can be precisely and securely fixed in the frame 68, and the liquid crystal display 21 can provide good quality, reliable display images. In addition, the fastening posts 642 and the fastening through-holes 662 help an operator to assemble the liquid crystal display 21 more easily. In particular, once the fastening through-holes 662 of the optical film 66 engagingly receive the fastening posts 642 of the diffusing plate 64, there is no need for the operator to further correct or adjust the location of the optical film 56.

In alternative embodiments of the present invention, each of the fastening posts 542, 642 can be in the form of a triangular, square, rectangular or multifaceted prism, and the fastening through-hole 562, 662 can be correspondingly triangular, square, rectangular or polygonal in cross-section. In another alternative embodiments, there is only one hatch in total, or only one hatch at each of the two opposite sides of the top bezel, or only three hatches in total, or five or more hatches in total (and there is a corresponding number of first protrusions each time). In addition, there is only one first ear in total, or only one first ear at each of the two opposite sides of the light guide plate, or only three first ears in total, or five or more first ears in total (and there is a corresponding number of second ears and first notches each time). Moreover, two or more first ears are at any selected one or more of the four sides of the light guide plate including said two opposite sides (and there is corresponding positioning of the second ears and first notches each time). Furthermore, the post can be formed on the second ears, and the fastening through-holes can be formed on the first ears.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A surface light source, comprising:
a light source,
an optical element configured for receiving light beams from the light source, guiding and uniformizing the light beams, and outputting the light beams;
an optical film positioned on the optical element and configured for receiving the output light beams; and
a frame accommodating the light source, the optical element and the optical film;
wherein at least one fastening post is formed on one of the optical element and the optical film, and at least one fastening hole is formed on the other of the optical element and the optical film, which is corresponding to the at least one fastening post, and the optical film is located at the optical element through the cooperation of the at least one fastening post and the at least one fastening hole.

2. The surface light source of claim 1, wherein each fastening post drills through one fastening hole.

3. The surface light source of claim 1, wherein the optical element is a light guide plate, and the light source is disposed adjacent one side of the light guide plate.

4. The surface light source of claim 1, wherein the optical element is a diffusing plate, and the light source is disposed under the diffusing plate.

5. The surface light source of claim 1, wherein the optical element has at least one first ear integrally extending from each side surface, each fastening post being formed at one first ear, or each fastening hole being formed at one first ear.

6. The surface light source of claim 5, wherein the optical film has at least one second ear integrally extending from each side surface, each fastening hole being formed at one second ear, or each fastening post being formed at one second ear.

7. The surface light source of claim 6, wherein the frame has at least one notch, positioned at least one inner long side of the frame, corresponding to the at least one first ear and the at least one second ear, and each notch receives one first ear and one second ear.

8. The surface light source of claim 1, wherein the fastening hole is circular-shaped or polygon-shaped.

9. The surface light source of claim 1, wherein the fastening post is cylinder or multifaceted prism.

10. The surface light source of claim 1, further comprising a reflector under the optical element.

11. A liquid crystal display, comprising:
a liquid crystal panel;
a surface light source providing surface light beams to the liquid crystal panel; and
a frame for accommodating the liquid crystal panel and the surface light source;
the surface light source comprising:
a light source;
an optical element configured for receiving light beams from the light source, guiding and uniformizing the light beams, and outputting the light beams;
an optical film positioned on the optical element and configured for receiving the output light beams; and
wherein at least one fastening post is formed on one of the optical element and the optical film, and at least one fastening hole is formed on the other of the optical element and the optical film, which is corresponding to the at least one fastening post, and the optical film is located at the optical element through the cooperation of the at least one fastening post and the at least one fastening hole.

12. The liquid crystal display of claim 11, wherein each fastening post drills through one fastening hole.

13. The liquid crystal display of claim 11, wherein the optical element is a light guide plate, and the light source is disposed adjacent one side of the light guide plate.

14. The liquid crystal display of claim 11, wherein the optical element is a diffusing plate, and the light source is disposed under the diffusing plate.

15. The liquid crystal display of claim 11, wherein the optical element has at least one first ear integrally extending from each side surface, and each fastening post is formed at one first ear, or each fastening hole being formed at one first ear.

16. The liquid crystal display of claim 15, wherein the optical film has at least one second ear integrally extending from each side surface, and each fastening hole is formed at one second ear, or each fastening post being formed at one second ear.

17. The liquid crystal display of claim 16, wherein the frame has at least one notch, positioned at least one inner long side of the frame, corresponding to the at least one first ear and the at least one second ear, and each notch receives one first ear and one second ear.

18. The liquid crystal display of claim 11, wherein the fastening hole is circular-shaped or polygon-shaped.

19. The liquid crystal display of claim 11, wherein the fastening post is cylinder or multifaceted prism.

20. A surface light source, comprising:
a light source,
an optical element configured for receiving light beams from the light source, guiding and uniformizing the light beams, and outputting the light beams;
an optical film positioned on the optical element and configured for receiving the output light beams; and
a frame accommodating the light source, the optical element and the optical film; wherein
a first engaging device is formed on a periphery of the optical element, and a second engaging device is formed on a periphery of the optical film under a condition that said first engaging device and said second engaging device are at least partially overlapped with each other in a horizontal direction so as to prevent relative horizontal movement between the optical element and the optical film.
